(19) United States
(12) Patent Application Publication
(10) Pub. No.: US 2020/0081663 A1
(43) Pub. Date: Mar. 12, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Takao MATSUI, Kanagawa (JP)

(73) Assignee: FUJI XEROX CO., LTD., Tokyo (JP)

(21) Appl. No.: 16/549,475

(22) Filed: Aug. 23, 2019

(30) Foreign Application Priority Data
Sep. 6, 2018 (JP) 2018-166752

(51) Int. Cl. G06F 3/12

(52) U.S. Cl. CPC G06F 3/1205; G06F 3/1263; G06F 3/1268

(57) ABSTRACT

An information processing apparatus includes a receiver, an extractor, a selector, and a sender. The receiver receives a print instruction. The extractor extracts a condition for selecting an image forming device from the print instruction. The selector selects an image forming device in accordance with the condition from among plural image forming devices to which the information processing apparatus is able to communicate. The sender sends the print instruction to the image forming device selected by the selector.

### CROSS-REFERENCE TO RELATED APPLICATIONS

This application is based on and claims priority under 35 USC 119 from Japanese Patent Application No. 2018-166752 filed Sep. 6, 2018.

### BACKGROUND

### (i) Technical Field

The present disclosure relates to an information processing apparatus and a non-transitory computer readable medium.

### (ii) Related Art

Japanese Unexamined Patent Application Publication No. 2017-045375 discloses a management apparatus to achieve the following technology. A job ticket including a print job and a postprocessing job analyzed in accordance with registered allocation conditions so as to separate the print job and the postprocessing job from each other. The print job is then allocated to a printer device and the postprocessing job is then allocated to a postprocessing device. In this management apparatus communicating with specific devices, allocation conditions for separating a print job and a postprocessing job included in a job ticket are registered. Then, a print job included in a received job ticket is analyzed based on the registered allocation conditions, so that the print job to be processed in the printer device and a postprocessing job to be processed in the postprocessing device are separated from each other.

### SUMMARY

An information processing apparatus which relays a print instructing device and an image forming device receives a print instruction from the print instructing device and sends it to the image forming device. If plural image forming devices are connected to the information processing apparatus, a user is required to select one of the image forming devices.

Aspects of non-limiting embodiments of the present disclosure relate to an information processing apparatus which is connected to plural image forming devices to communicate with them and which is capable of selecting an image forming device without any user intervention when sending a print instruction to one of the plural image forming devices, and also relate to a non-transitory computer readable medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a receiver, an extractor, a selector, and a sender. The receiver receives a print instruction. The extractor extracts a condition for selecting an image forming device from the print instruction. The selector selects an image forming device in accordance with the condition from among plural image forming devices to which the information processing apparatus is able to communicate. The sender sends the print instruction to the image forming device selected by the selector.

### BRIEF DESCRIPTION OF THE DRAWINGS

An exemplary embodiment of the present disclosure will be described in detail based on the following figures, wherein:

FIG. 1 is a block diagram illustrating conceptual modules forming an example of the configuration of the exemplary embodiment;

FIGS. 2A and 2B illustrate examples of the system configuration utilizing the exemplary embodiment;

FIG. 3 illustrates an example of processing executed by the exemplary embodiment;

FIG. 4 is a flowchart illustrating an example of processing executed by the exemplary embodiment;

FIG. 5 illustrates an example of the data structure of a print job table;

FIG. 6 illustrates an example of the data structure of an image forming device attribute information table;

FIG. 7 illustrates an example of the data structure of an image forming device status information table;

FIG. 8 is a flowchart illustrating an example of processing executed by the exemplary embodiment;

FIG. 9 is a flowchart illustrating an example of processing executed by the exemplary embodiment;

FIG. 10 illustrates an example of the data structure of a print job table; and

FIG. 11 is a block diagram illustrating an example of the hardware configuration of a computer implementing the exemplary embodiment.

### DETAILED DESCRIPTION

An exemplary embodiment of the disclosure will be described below with reference to the accompanying drawings.

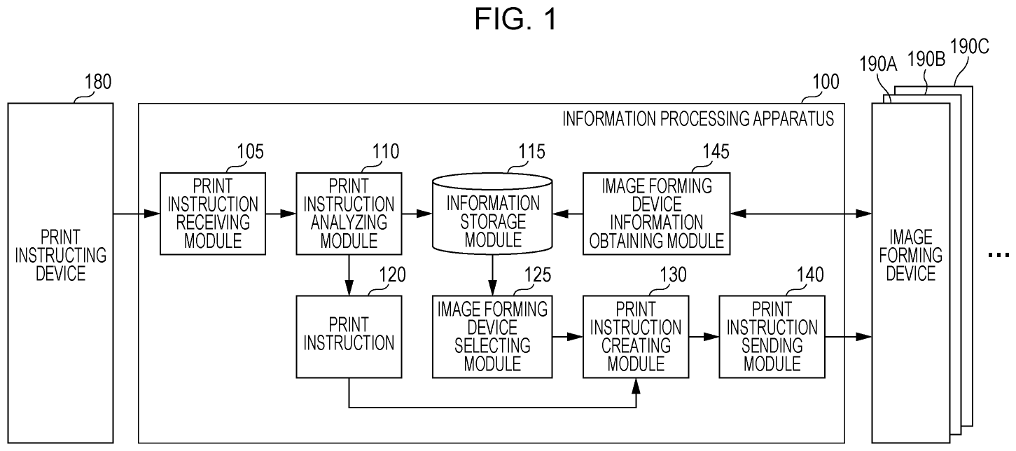

FIG. 1 is a block diagram illustrating conceptual modules forming an example of the configuration of the exemplary embodiment.

Generally, modules are software (computer programs) components or hardware components that can be logically separated from one another. The modules of the exemplary embodiment of the disclosure are, not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program will be stored in a storage device. Modules may correspond to functions based on a one-to-one relationship, in terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, login, etc.). The term “predetermined” means being determined prior to a certain operation, and includes the meaning of being determined prior a certain operation before starting processing of the exemplary embodiment, and also includes the meaning of being determined prior to a certain operation even after starting processing of the exemplary embodiment, in accordance with the current situation/state or in accordance with the previous situation/state, if there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary. If elements are enumerated, such as “A, B, and C”, they are only examples unless otherwise stated, and such enumeration includes the meaning that only one of them (only the element A, for example) is selected.

A system or an apparatus may be implemented by connecting plural computers, hardware units, devices, etc., to one another via a communication medium, such as a network (including communication connection based on a one-to-one correspondence), or may be implemented by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processing result is written into the storage device. A description of reading from the storage device before an operation or writing into the storage device after an operation may be omitted. Examples of the storage device may be a hard disk drive, a random access memory (RAM), an external storage medium, a storage device using a communication line, and a register within a central processing unit (CPU).

An information processing apparatus 100 according to the exemplary embodiment executes allocation processing for print jobs. As shown in the example in FIG. 1, the information processing apparatus 100 includes a print instruction receiving module 105, a print instruction analyzing module 110, an information storage module 115, an image forming device selecting module 125, a print instruction creating module 130, a print instruction sending module 140, and an image forming device information obtaining module 145. The information processing apparatus 100 is connected to a print instructing device 180 and plural image forming devices 190 so as to communicate with them. More specifically, the information processing apparatus 100 receives a print job from the print instructing device 180, selects an image forming device 190 suitable for the print job, and sends the print job to the selected image forming device 190.

The image forming devices 190 (such as image forming devices 190A, 190B, and 190C) are connected to the print instruction sending module 140 and the image forming device information obtaining module 145 of the information processing apparatus 100.

An example of the image forming devices 190 is a production printer. The production printer performs light printing for in-house printing departments of companies and print stores, and usually offers mass printing. The image forming devices 190 are not restricted to production printers, and may be general-purpose printers, such as business printers and home printers.

Hereinafter, when referring to the image forming devices 190 in general, they may collectively be called the image forming device 190 unless it is necessary to individually distinguish them from each other.

The image forming device 190 may not be necessarily able to handle a group print job constituted by multiple print jobs. Even if the image forming device 190 does not support a group print job, that a, even if it handles only a single print job, it can still handle a group print job if the information processing apparatus 100 sends print jobs forming a group print job to the image forming device 190 in accordance with the print order of the group print job. That is, it is possible to handle a group print job by using both of the information processing apparatus 100 and the image forming device 190.

Some of the image forming devices 190 may be an output device for continuous-form paper and an output device for cut sheet Examples of the continuous-form paper are roll paper, line printer (LP) paper, and continuous paper. The cut sheets are sheets cut into a standard size (such as A4, A3, B4, and B5 sizes). The output device for cut sheets a certain size thus includes feeders for cut sheets of this size (such as a sheet feeder, a sheet feeder tray, a sheet tray, a sheet feeder cassette, and a deck).

In FIG. 1, one print instructing device 180 and three image forming devices 190 are shown. However, plural print instructing devices 180 may be provided, and any plural image forming devices 190 may be provided.

The print instruction receiving module 105 is connected to the print instruction analyzing module 110 and the print instructing device 180. The print instruction receiving module 105 receives a print instruction (hereinafter may also be called a print job) from the print instructing device 180 and supplies it to the print instruction analyzing module 110.

A print instruction is constituted by a data group for instructing the image forming device 190 to perform printing. An example of the print instruction is a job definition format (JDF), which is also called a print job ticket. The print instruction includes a document to be printed and attribute information concerning the document. The print instruction receiving module 105 receives a print instruction subjected to prepress processing executed by the print instructing device 180.

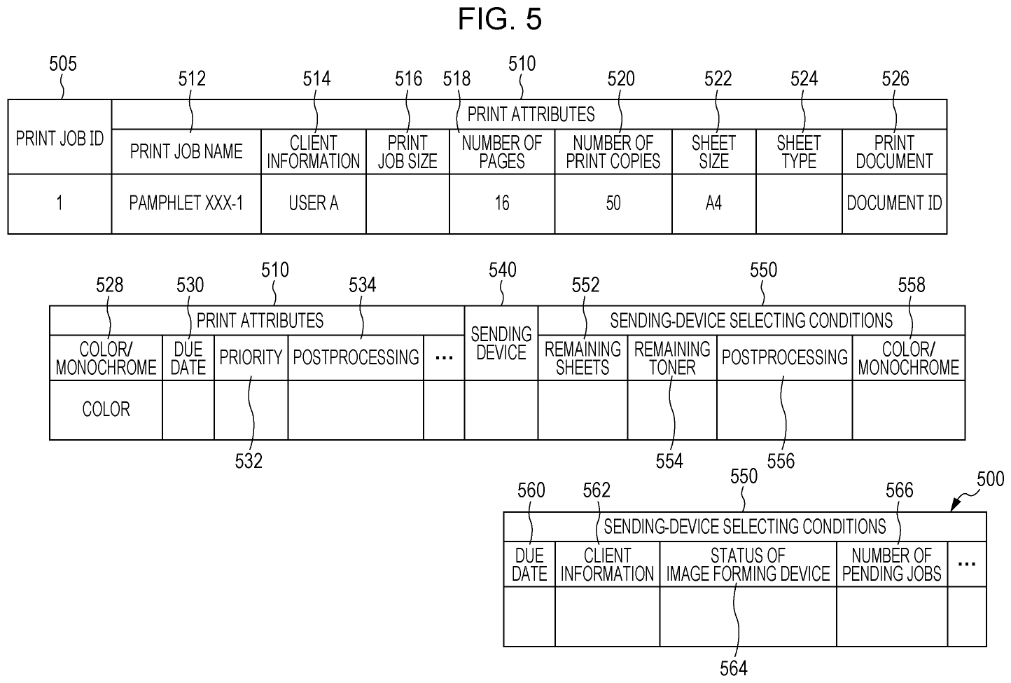

An example of the print instruction is a print job table 500, which will be discussed later with reference to FIG. 5.

The print instruction analyzing module 110 is connected to the print instruction receiving module 105, the information storage module 115, and the print instruction creating module 130. The print instruction analyzing module 110 supplies a print instruction 120 to the print instruction creating module 130. The print instruction analyzing module 110 writes information described in a print instruction in the information storage module 115. The print instruction analyzing module 110 also extracts a condition for selecting an image forming device 190 from the print instruction and stores the extracted condition in the information storage module 115.

The information storage module 115 is connected to the print instruction analyzing module 110, the image forming device selecting module 125, and the image forming device information obtaining module 145. The information storage module 115 stores information obtained by the print instruction analyzing module 110 and the image forming device information obtaining module 145.

The image forming device selecting module 125 is connected to the information storage module 115 and the print instruction creating module 130. Based on the condition for selecting an image forming device 190, the image forming device selecting module 125 selects an image forming device 190 to which a print instruction will be sent from among the plural image forming devices 190.

The image forming device selecting module 125 may select an image forming device 190 in a status which satisfies the condition.

The image forming device selecting module 125 may select an image forming device 190 having an attribute which satisfies the condition.

More specifically, the image forming device selecting module 125 obtains the condition, the print instruction, and information concerning the image forming devices 190 from the information storage module 115 and selects an image forming device 190 to which the print instruction will be sent.

The condition may be a condition which is set in a print instruction. A print attribute concerning the print instruction is also set in the print instruction.

The image forming device selecting module 125 may select an image forming device 190 in accordance with the print attribute and the condition set in the print instruction.

If the condition is inconsistent with the print attribute set in the print instruction, the image forming device selecting module 125 may select an image forming device 190 in accordance with the print attribute.

For example, if the print attribute indicates that stapling is not required, but if the condition indicates that stapling is required, the image forming device selecting module 125 selects an image forming device 190 in accordance with the print attribute indicating that stapling is not required.

Priority levels may be provided for plural conditions set in the print instruction. The priority levels may be described in the print instruction for the individual conditions or may simply accord with the order of conditions described in the print instruction. The priority levels may have been set in accordance with a user operation or a predetermined rule. An example of the predetermined rule is that a condition concerning a postprocessing function provided in an image forming device 190 is the first priority level.

If only one image forming device 190 matches a condition of a higher priority level, the image forming device selecting module 125 may select this image forming device 190.

For example, the image forming device selecting module 125 extracts image forming devices 190 that satisfy the conditions in descending order of priority, and when it has found only one image forming device 190 that satisfies a condition of a certain priority level, it selects this image forming device 190. This is because the image forming device selecting module 125 is unable to narrow down image forming devices 190 any further. Even if the image forming device selecting module 125 continues to extract image forming devices 190 that satisfy a condition, it may not be able to find any image forming device 190 and fail to select an image forming device 190. The extracted image forming device 190 that satisfies a condition of a higher priority level is not required to satisfy a condition with a lower priority level.

The print instruction creating module 130 is connected to the print instruction analyzing module 110, the image forming device selecting module 125, and the print instruction sending module 140. The print instruction creating module 130 receives the print instruction 120 from the print instruction analyzing module 110, writes information indicating the sending device (image forming device 190) selected by the image forming device selecting module 125 in the print instruction 120, and supplies it to the print instruction sending module 140.

The print instruction sending module 140 is connected to the print instruction creating module 130 and the image forming devices 190 (such as the image forming devices 190A, 190B, and 190C). The print instruction sending module 140 sends a print instruction created by the print instruction creating module 130 to the image forming device 190 selected by the image forming device selecting module 125.

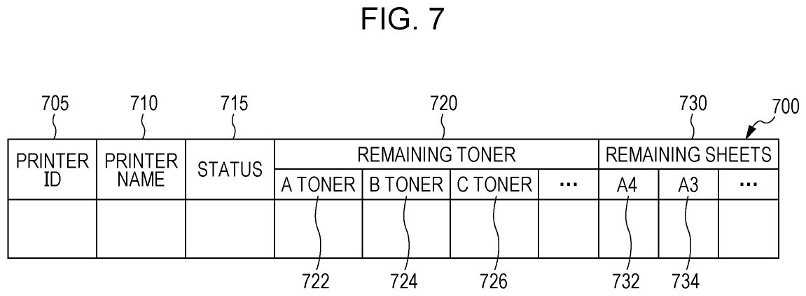

The image forming device information obtaining module 145 is connected to the information storage module 115 and the image forming devices 190 (such as the image forming devices 190A, 190B, and 190C). The image forming device information obtaining module 145 obtains information concerning the statuses of the image forming devices 190. For example, the image forming device information obtaining module 145 obtains status infer at concerning each image forming device 190 on a regular basis. An example of the status information is an image forming device status information table 700, which will be discussed later with reference to FIG. 7.

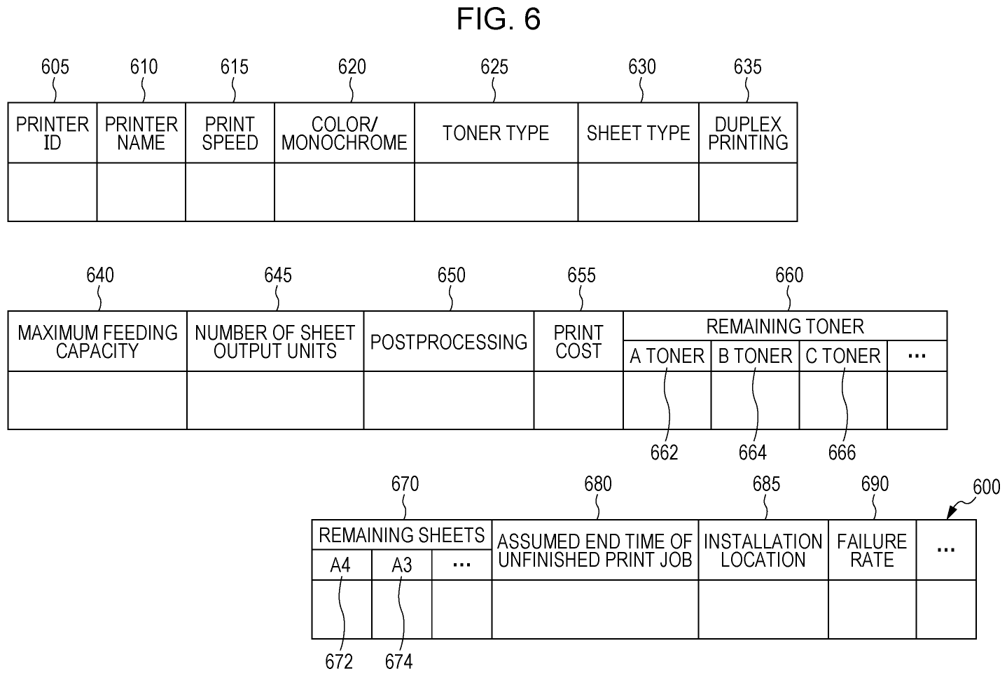

The image forming device information obtaining module 145 may obtain attributes of the image forming devices 190. For example,the image forming device information obtaining module 145 obtains attribute information concerning each image forming device 190 on a regular basis. An example of the attribute information is an image forming device attribute information table 600, which will be discussed later with reference to FIG. 6.

The print instructing device 180 is connected to the print instruction receiving module 105 of the information processing apparatus 100. The print instructing device 180 executes prepress processing, which is print preprocessing, and sends a resulting print instruction to the information processing apparatus 100. More specifically, the print instructing device 180 performs processing, such as planning, designing, editing, typesetting (desktop publishing (DTP)), proofreading, and computer-to-plate (CTP) processing, so as to generate a print instruction. The print instructing device 180 may add information for selecting an image forming device 190 to perform printing to the print instruction or may request the information processing apparatus 100 to select an image forming device 190 without selecting one by itself.

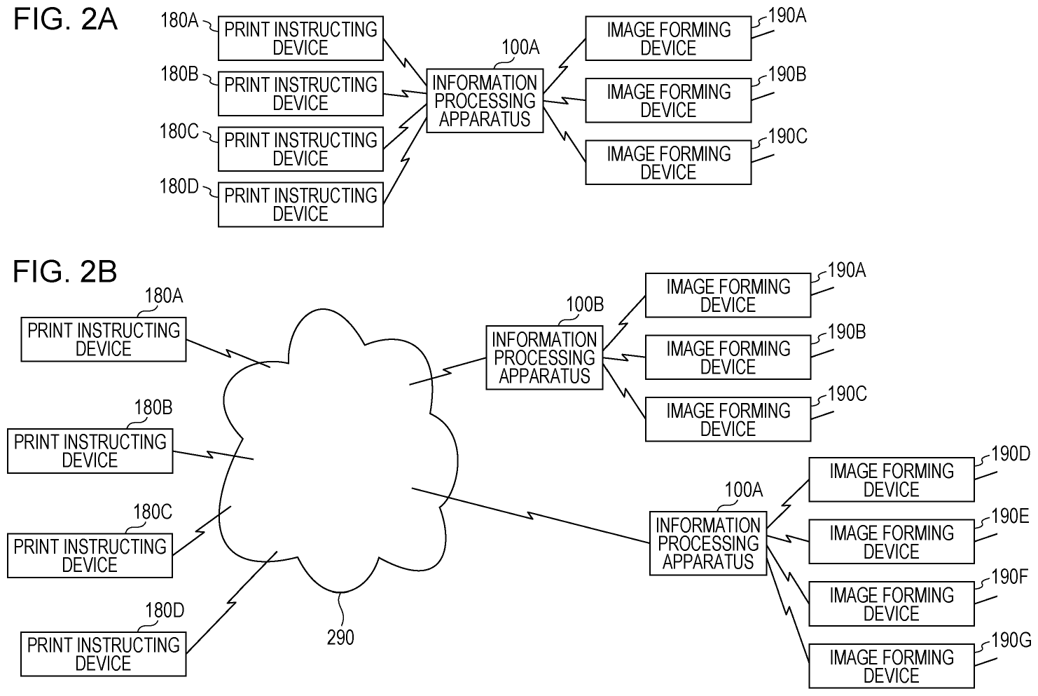

FIGS. 2A and 2B illustrate examples of the system configuration utilizing the exemplary embodiment.

The information processing apparatus 100 may be included within an external controller of the image forming device 190.

In the example shown in FIG. 2A, an information processing apparatus 100A is connected to print instructing devices 180 (print instructing devices 180A through 180D) and image forming devices 190 (image forming devices 190A through 190C).

Hereinafter, when referring to the print instructing devices 180 in general, they may collectively be called the print instructing device 180 unless it is necessary to individually distinguish them from each other.

The information processing apparatus 100A receives a print job or a group print job from the print instructing device 180 and supplies the received print job or group print job to the image forming device 190 suitable for the print job or the group print job. The image forming device 190 performs print processing in accordance with the received print job or group print job.

In the example in FIG. 2B, information processing apparatuses 100A and 100B and print instructing devices 180A through 180D are connected to each other via a communication line 290. The communication line 290 may be a wireless or wired medium, or a combination thereof, and may be, for example, the Internet or an intranet as a communication infrastructure. The functions of the information processing apparatuses 100A and 100B may be implemented as cloud services.

The information processing apparatus 100A is connected to image forming devices 190A through 190C.

The information processing apparatus 100B is connected to image forming devices 190D through 190G.

Hereinafter, when referring to the information processing apparatuses 100 in general, they may collectively be called the information processing apparatus 100 unless it is necessary to individually distinguish them from each other.

The information processing apparatus 100 receives a print job or a group print job from the print instructing device 180 via the communication line 290 and supplies the received print job or group print job to the image forming device 190 suitable for the received print job or group print job. The image forming device 190 performs print processing in accordance with the received print job or group print job.

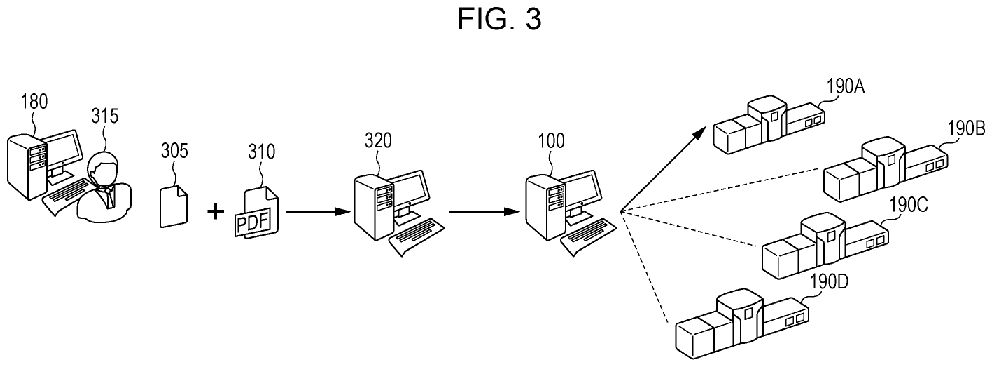

FIG. 3 is a schematic view for explaining an example of processing executed by the exemplary embodiment.

The print instructing device 180 generates a print job (a print job ticket 305 and a print document 310) as a result of a user 315 performing an operation. The print document 310 is a document described in a page document format (PDF), for example. A prepress device 320 executes prepress processing on the print job (principally print document 310). The print job subjected to prepress processing is supplied to the information processing apparatus 100 and further to one of the image forming devices 190A through 190D to perform print processing.

The information processing apparatus 100 has a function as a spooler for allocating print jobs. For example, the information processing apparatus 100 may write information indicating an image forming device 190 in a received print job or in a print job to be sent.

In the related art, an image forming device 190 is set as a sending device in a print job in the following manner.

When print processing is executed according to a print workflow, it is possible to set an image forming device 190 to perform printing in a print job.

When a print job is received or sent by a prepress device or a spooler, an image forming device 190 may be selected as a sending device in advance.

A receive folder for print jobs may be prepared, and when creating this receive folder, an image forming device 190 to perform printing may be set as a default sending device. If a sending device is not described in a print job, the default image forming device 190 in the receive folder is set in the print job.

Selecting a sending device in the above-described manner, however, fails to select an image forming device 190 based on the statuses of image forming devices 190 or an attribute of a print job which is desirably selected preferentially.

For example, if the default image forming device 190 set in the receive folder is out of toner when sending a print job, it is preferable to avoid using this image forming device 190.

When a default image forming device 190 is not described in a print job, the information processing apparatus 100 of this embodiment sets the image forming device 190 that best matches the conditions described in the print job as a sending device. For example, the information processing apparatus 100 checks the attributes or the statuses of the image forming devices 190 against the attributes or the conditions described in the print job. Conditions for selecting an image forming device 190 are set in a print job, thereby making it possible to dynamically select an image forming device 190 as a sending device. If a default image forming device 190 is set in a print job, conditions described in the print job may be ignored.

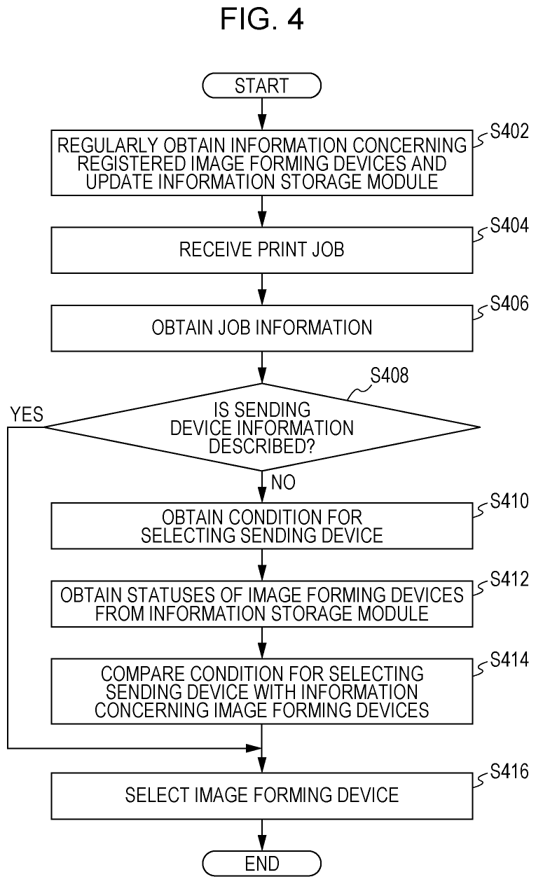

FIG. 4 is a flowchart illustrating an example of processing executed by the exemplary embodiment. More specifically, FIG. 4 illustrates an example of processing executed from when a print job is received until when an image forming device 190 is selected as a sending device. As a preprocessing step, image forming devices 190 may be registered and a default image forming device 190 may optionally be set. As a postprocessing step, the print job is sent to the selected image forming device 190.

In step S402, the image forming device information obtaining module 145 obtains information concerning the registered image forming devices 190 on a regular basis and updates the information storage module 115. For example, the image forming device information obtaining module 145 receives the image forming device attribute information table 600 and the image forming device status information table 700 from each image forming device 190. FIG. 6 illustrates an example of the data structure of the image forming device attribute information table 600.

The image forming device attribute information table 600 has a printer ID field 605, a printer name field 610, a print speed field 615, a color/monochrome field 620, a toner type field 625, a sheet type field 630, a duplex printing field 635, a maximum feeding capacity field 640, a number-of-sheet-output-units field 645, a postprocessing field 650, a print cost field 655, a remaining toner field 660, a remaining sheet field 670, a field 680 for the assumed end time of an unfinished print job, an installation location field 685, and a failure rate field 690. The remaining toner field 660 has an A toner field 662, a B toner field 664, a C toner field 666, and so on. The remaining sheet field 670 has an AA field 672, an A3 field 674, and so on.

The printer ID field 605 stores information (printer ID) for uniquely identifying the image forming device 190 in the exemplary embodiment. The printer name field 610 indicates the name of the image forming device 190. The print speed field 615 indicates the print speed of the image forming device 190. Plural print speed fields may be provided in accordance with plural sheet types (such as A4 size and A3 size). The color/monochrome field 620 stores information (flag) whether the image forming device 190 is able to perform color printing or only monochrome printing The toner type field 625 indicates toner types that can be stored in the image forming device 190, such as the types of color toners (black, cyan, magenta, yellow, and spot color toners). The sheet type field 630 indicates sheet types that can be stored in the image forming device 190. The duplex printing field 635 stores information (flag) whether the image forming device 190 is able to perform duplex printing. The maximum feeding capacity field 640 indicates the maximum feeding capacity of the image forming device 190. The number-of-sheet-output-units field 645 indicates the number of sheet output units provided in the image forming device 190. The number-of-sheet-output-units field 645 may also indicate the capacity of each of the sheet output units (the number of output sheets that can be received by an output sheet receiver). The postprocessing field 650 indicates postprocessing functions of the image forming device 190. The print cost field 655 indicates the print cost of the image forming device 190. The remaining toner field 660 indicates the current amount of toner in the image forming device 190. The A toner field 662 indicates the remaining amount of A toner. The B toner field 664 indicates the remaining amount of B toner. The C toner field 666 indicates the remaining amount of C toner. In addition to the remaining toner fields for black, cyan, magenta, and yellow toners, the remaining toner field 660 may include remaining toner fields for spot color toners supported by the image forming device 190. The remaining sheet field 670 indicates the currently remaining sheets in the image forming device 190. The A4 field 672 indicates the remaining A4 sheets. The A3 field 674 indicates the remaining A3 sheets. The field 680 for the assumed end time of an unfinished print job indicates the assumed time at which an unfinished print job will be finished in the image forming device 190. The installation location field 685 indicates the installation location of the image forming device 190. The failure rate field 690 indicates the failure rate (for example, how often a paper jam has occurred) of the image forming device 190.

FIG. 7 illustrates an example of the data structure of the image forming device status information table 700. The image forming device status information table 700 has a printer ID field 705, a printer name field 710, a status field 715, a remaining toner field 720, and a remaining sheet field 730. The remaining toner field 720 has an A toner field 722, a B toner field 724, a C toner field 726, and so on. The remaining sheet field 730 has an A4 field 732, an A3 field 734, and so on.

The printer ID field 705 indicates the printer ID for uniquely identifying the image forming device 190. The printer name field 710 indicates the name of the image forming device 190. The status field 715 indicates the status of the image forming device 190. The remaining toner field 720 indicates the current amount of toner in the image forming device 190. The A toner field 722 indicates the remaining amount of A toner. The B toner field 724 indicates the remaining amount of B toner. The C toner field 726 indicates the remaining amount of C toner. In addition to the remaining toner fields for black, cyan, magenta, and yellow toners, the remaining toner field 720 may include remaining toner fields for spot color toners supported by the image forming device 190. The remaining sheet field 730 indicates the currently remaining sheets in the image forming device 1.90. The A4 field 732 indicates the remaining A4 sheets. The A3 field 734 indicates the remaining A3 sheets.

The status field 715 indicates whether the image forming device 190 is powered OFF, setting up, idling, or printing and whether an error (such as a paper jam, out of paper, a print job receiving error, a print job reading error, out of toner, cover opening, communication error, and an unknown error) is occurring in the image forming device 190. The status field 715 also indicates the number of pending print jobs.

Referring back to FIG. 4, in step S404, the print instruction receiving module 105 receives a print job, such as the print job table 500, from the print instructing device 180. FIG. 5 illustrates an example of the data structure of the print job table 500. The print job table 500 has a print job ID field 505, a print attribute field 510, a sending device field 540, and a sending-device selecting condition field 550. The print attribute field 510 has a print job name field 512, a client information field 514, a print job size field 516, a number-of-pages field 518, a number-of-print-copies field 520, a sheet size field 522, a sheet type field 524, a print document field 526, a color/monochrome field 528, a due-date field 530, a priority field 532, and a postprocessing field 534. The sending-device selecting condition field 550 has a remaining sheet field 552, a remaining toner field 554, a postprocessing field 556, a color/monochrome field 558, a due-date field 560, a client information field 562, an image-forming-device status field 564, and a number-of-pending-jobs field 566.

The print job ID field 505 stores information (print job ID) for uniquely identifying a print job in the exemplary embodiment. The print attribute field 510 stores print attributes of this print job. The print job name field 512 indicates the name of the print job. The client information field 514 stores client information. The print job size field 516 indicates the size of the print job (such as the size of a print document). The number-of-pages field 518 indicates the number of pages of a print document in the print job. The number-of-print-copies field 520 indicates the number of print copies to be printed in the print job. The sheet size field 522 indicates the sheet size (such as A4 or B5) to be used in the print job. The sheet type field 524 indicates the sheet type (such as glossy paper) to be used in the print job. The print document field 526 stores or indicates a print document in the print job. The print document field 526 may store the print document itself or may indicate the location where the print document is stored (such as a document ID, a document name, and a uniform resource locator (URL)). The color/monochrome field 528 stores information (flag) whether the print job concerns color printing or monochrome printing. In the color/monochrome field 528, not only information whether color printing or monochrome printing is performed, but also information whether printing using a spot color (gold, silver, and fluorescent colors) is performed may also be described. The due-date field 530 indicates the due date of a printed matter to be generated by the print job. The priority field 532 indicates the priority of the print job. The postprocessing field 534 indicates postprocessing (such as stapling, punching, and bookbinding) to be performed in the print job. The sending device field 540 indicates an image forming device 190 to be used as a sending device. The sending device field 540 may be left blank without indicating an image forming device 190. The sending device selecting condition field 550 indicates conditions for selecting a sending device. The remaining sheet field 552 indicates, as a condition, remaining sheets to be stored in the image forming device 190. That is, one of the conditions for selecting a sending device is that the image forming device 190 stores at least the number of sheets indicated in the remaining sheet field 552. The remaining toner field 554 indicates, as a condition, the remaining amount of toner to be stored in the image forming device 190. The postprocessing field 556 indicates, as a condition, postprocessing functions provided in the image forming device 190. The color/monochrome field 558 indicates, as a condition, whether the image forming device 190 is required to perform color printing or only monochrome printing. The due-date field 560 indicates, as a condition, the due date on which the image forming device 190 is due to finish printing this print job. The client information field 562 stores client information as a condition. For example, clients and image forming devices 190 are associated with each other, and if a client is indicated in the client information field 562, the image forming device 190 associated with this client is selected. The image-forming-device status field 564 indicates, as a condition, the required status of the image forming device 190. The number-of-pending-jobs field 566 indicates, as a condition, the maximum number of pending print jobs in the image forming device 190.

In step S406, the print instruction analyzing module 110 analyzes the print job so as to obtain sending device information (image forming device 190 described in the print job) and a selecting condition.

In step S408, the image forming device selecting module 125 judges whether sending device information is described in the print job. If sending device information is described in the print job, the process proceeds to step S415. If sending device information is not described in the print job, the process proceeds to step S410.

In step S410, the image forming device selecting module 125 obtains a condition for selecting the sending device.

In step S412, the image forming device selecting module 125 obtains the statuses of the image forming devices 190 from the information storage module 115.

In step S414, the image forming device selecting module 125 compares the condition for selecting the sending device with information concerning the image forming devices 190. More specifically, the image forming device selecting module 125 judges whether the content of the image forming device attribute information table 600 or that of the image forming device status information table 700 concerning each image forming device 190 matches the condition stored in the sending-device selecting condition field 550 of the print job table 500.

In step S416, the image forming device selecting module 125 selects an image forming device 190 to perform printing. If plural conditions for selecting the sending device are provided, the image forming device selecting module 125 selects the image forming device 190 that best matches the conditions.

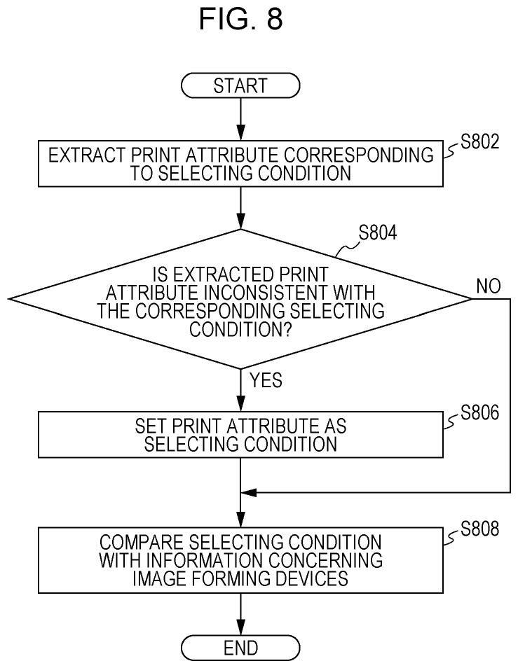

Step S414 in the flowchart in FIG. 4 may be executed by processing in the flowchart in FIG. 8.

FIG. 8 is a flowchart illustrating an example of processing executed by the exemplary embodiment.

In step S802, the image forming device selecting module 125 extracts a print attribute corresponding to a condition for selecting an image forming device 190. In the print job table 500 shown in FIG. 5, for example, the color/monochrome field 528 of the print attribute field 510 corresponds to the color/monochrome field 558 of the sending-device selecting condition field 550. The client information 514 of the print attribute field 510 and the client information 562 of the sending-device selecting condition field 550 also correspond to each other. The due-date field 530 of the print attribute field 510 and the due-date field 560 of the sending-device selecting condition field 550 also correspond to each other. The postprocessing field 534 of the print attribute field 510 and the postprocessing field 556 of the sending-device selecting condition field 550 also correspond to each other.

In step S804, the image forming device selecting module 125 judges whether the content of one field and that of the corresponding field are inconsistent with each other. If the two corresponding fields are inconsistent with each other, the process proceeds to step S806. If the two corresponding fields are not inconsistent with each other, the process proceeds to step S808. If, for example, the content of the color/monochrome field 528 of the print attribute field 510 is inconsistent with that of the color/monochrome field 558 of the sending-device selecting condition field 550, the result of step 5804 is YES.

In step S806, the print attribute is set as a condition for selecting the image forming device 190. In the above-described example, the content of the color/monochrome field 528 of the print attribute field 510 is set as a condition, instead of the content of the color/monochrome field 558 of the sending-device selecting condition field 550.

In step S808, the image forming device selecting module 125 compares the condition for selecting the sending device with information concerning the image forming devices 190. Step S808 is equivalent to step S414 of FIG. 4. In step S808, however, some of the conditions (if plural conditions are set) may have been replaced by attributes as a result of executing step S806.

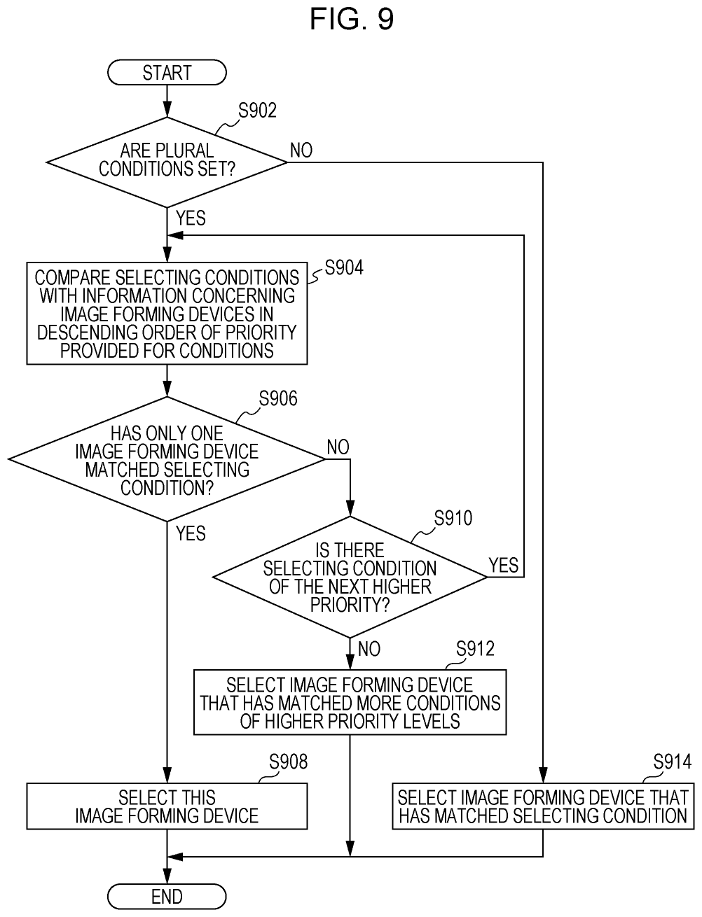

FIG. 9 is a flowchart illustrating an example of processing executed by the exemplary embodiment. More specifically, FIG. 9 illustrates an example of processing when plural selecting conditions are set. Step S414 in the flowchart in FIG. 4 and step S808 in the flowchart in FIG. 8 may be replaced by processing in the flowchart in FIG. 9.

In step S902, the image forming device selecting module 125 judges whether plural selecting conditions are set. If plural conditions are set, the process proceeds to step S904. If plural conditions are not set, the process proceeds to step S914.

In step S904, the image forming device selecting module 125 compares the selecting conditions and information concerning the image forming devices 190 with each other in descending order of priority set for the conditions.

In step S906, the image forming device selecting module 125 judges whether only one image forming device 190 has matched a selecting condition of a higher priority level. If the result of step S906 is YES, the process proceeds to step S908. If the result of step S906 is NO, the process proceeds to step S910.

In step S908, the image forming device selecting module 125 selects this image forming device 190.

In step S910, the image forming device selecting module 125 judges whether there is a selecting condition of the next higher priority. If the result of step S910 is YES, the process returns to step S904. If the result of step S910 is NO, the process proceeds to step S912.

In step S912, the image forming device selecting module 125 selects the image forming device 190 that has matched more conditions of higher priority levels.

In step S914, the image forming device selecting module 125 selects the image forming device 190 that has matched the selecting condition.

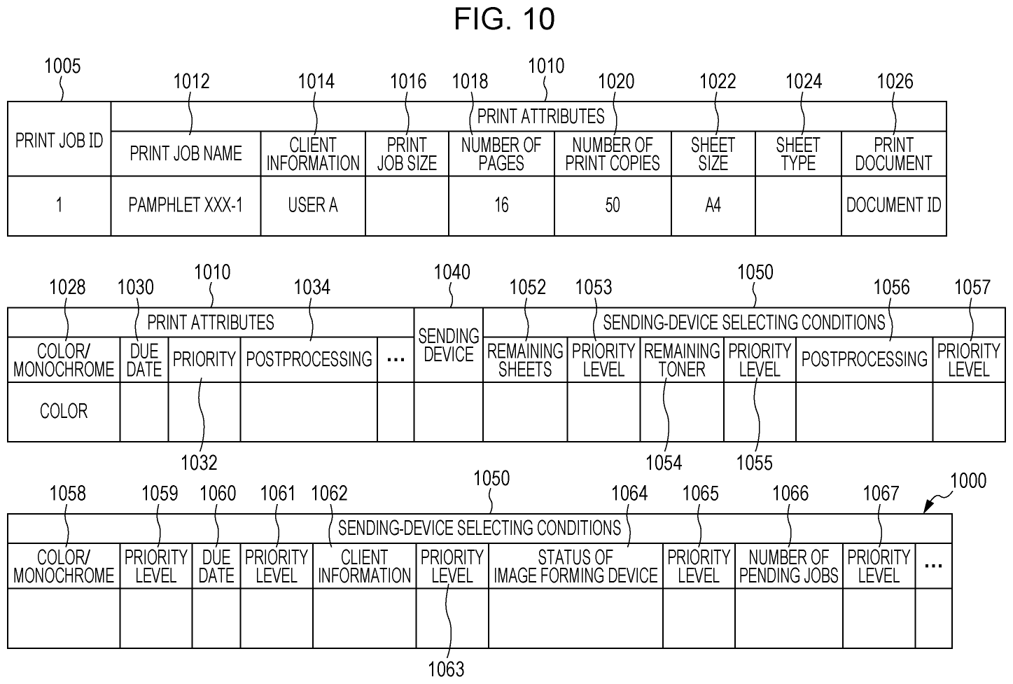

An example which priority levels are provided for the conditions in the sending-device selecting condition field 550 of the print job table 500 is shown as a print job table 1000. FIG. 10 illustrates an example of the data structure of the print job table 1000. The print job table 1000 has a print job ID field 1005, a print attribute field 1010, a sending device field 1040, and a sending-device selecting condition field 1050. The print attribute field 1010 has a print job name field 1012, a client information field 1014, a print job size field 1016, a number-of-pages field 1018, a number-of-print-copies field 1020, a sheet size field 1022, a sheet type field 1024, a print document field 1026, a color/monochrome field 1028, a due-date field 1030, a priority field 1032, and a postprocessing field 1034. The sending-device selecting condition field 1050 has a remaining sheet field 1052, a priority level field 1053, a remaining toner field 1054, a priority level field 1055, postprocessing field 1056, a priority level field 1057, a color/monochrome field 1058, a priority level field 1059, a due-date field 1060, a priority level field 1061, a client information field 1062, a priority level field 1063, an image-forming-device status field 1064, a priority level field 1065, a number-of-pending-jobs field 1066, and a priority level field 1067.

The print job ID field 1005 stores a print job ID. The print attribute field 1010 stores print attributes. The print job name field 1012 indicates the name of the print job. The client information field 1014 stores client information. The print job size field 1616 indicates the size of the print job. The number-of-pages field 1018 indicates the number of pages of a print document in the print job. The number-of-print-copies field 1020 indicates the number of print copies to be printed in the print job. The sheet size field 1022 indicates the sheet size to be used in the print job. The sheet type field 1024 indicates the sheet type to be used in the print job. The print document field 1026 stores or indicates a print document in the print job. The print document field 1026 may store the print document itself or may indicate the location where the print document is stored (such as a document ID, a document name, and a URL). The color/monochrome field 1028 stores information whether the print job concerns color printing or monochrome printing. In the color/monochrome field 1028, not only information whether color printing or monochrome printing is performed, but also information whether printing using a spot color (gold, silver, and fluorescent colors) is performed may also be described. The due-date field 1030 indicates the due date of the print job. The priority field 1032 indicates the priority of the print job. The postprocessing field 1034 indicates postprocessing (such as stapling, punching, and bookbinding) to be performed in the print job. The sending device field 1040 indicates an image forming device 190 to be used as a sending device. The sending device field 1040 may be left blank without indicating an image forming device 190. The sending-device selecting condition field 1050 indicates conditions for selecting a sending device. The remaining sheet field 1052 indicates, as a condition, remaining sheets to be stored in the image forming device 190. That is, one of the conditions for selecting a sending device is that the image forming device 190 stores at least the number of sheets indicated in the remaining sheet field 1052. The priority level field 1053 indicates the priority level of the remaining sheets. The remaining toner field 1054 indicates, as a condition, the remaining amount of toner to be stored in the image forming device 190. The priority level field 1055 indicates the priority level of the remaining toner. The postprocessing field 1056 indicates, as a condition, postprocessing functions provided in the image forming device 190. The priority level field 1057 indicates the priority level of the postprocessing functions, color/monochrome field 1058 indicates, as a condition, whether the image forming device 190 is required to perform color printing or only monochrome printing. The priority level field 1059 indicates the priority level of color/monochrome printing. The due-date field 1060 indicates, as a condition, the due date on which the image forming device 190 is due to finish printing this print job. The priority level field 1061 indicates the priority level of the due date. The client information field 1062 stores client information as a condition. For example, clients and image forming devices 190 are associated with each other, and if a client is indicated in the client information field 1062, the image forming device 190 associated with this client is selected. The priority level field 1063 indicates the priority level of the client information. The image-forming-device status field 1064 indicates, as a condition, the required status of the image forming device 190. The priority level field 1065 indicates the priority level of the status of the image forming device 190. The number-of-pending-jobs field 1066 indicates, as a condition, the maximum number of pending print jobs in the image forming device 190. The priority level field 1067 indicates the priority level of the maximum number of pending jobs.

An example of processing executed by the information processing apparatus 100 will be described below.

The image forming devices 190A, 190B, and 190C are connected to the information processing apparatus 100. A default image forming device 190 is not set in a print job received by the information processing apparatus 100.

The information processing apparatus 100 communicates with each image forming device 190 on a regular basis and obtains the status and attributes of each image forming device 190.

The obtained information concerning each image forming device 190 is stored in the information storage module 115.

The color/monochrome information, the remaining sheets, and the remaining toner concerning each image forming device 190 are as follows
Image forming device 190A: monochrome, remaining sheets 100%, and remaining toner 50%;
Image forming device 190B: color, remaining sheets 50%, and remaining toner 75%; and
Image forming device 190C: color, remaining sheets 50%, and remaining toner 50%.

The color/monochrome attribute (color/monochrome field 528 of the print job table 500) of a received print job A is as follows.
Print job A: color

The conditions for selecting an image forming device 190 as a sending device are indicated as follows in descending order of priority:
(1) Monochrome printing;
(2) More remaining sheets; and
(3) More remaining toner.

Among these conditions, (1) monochrome printing is inconsistent with the attribute “color”. The attribute “color” is thus used as a condition. As a result, the conditions for selecting a sending device are as follows in descending order of priority:
(1) Color printing;
(2) More remaining sheets; and
(3) More remaining toner.

Among the image forming devices 190A, 190B, and 190C, the image forming device 190B best matches the conditions and is thus selected as a device to which the print job A will be sent. More specifically, the image forming devices 190B and 190C are selected based on the condition (1), neither of the image forming device 1903 nor the image forming device 190C is selected based on the condition (2), and then, the image forming device 1903 is selected based on the condition (3).

The following condition may be added in a selecting-condition field: if a selecting condition and an attribute in a print job correspond to each other, the attribute is used as a selecting condition. For example, in the color/monochrome field 558 of the sending-device selecting condition field 550, in addition to “color” and “monochrome”, “using the attribute (color/monochrome field 528)” may be set as a condition. In this case, the condition and the attribute are not inconsistent with each other.

If plural image forming devices 190 have matched a selecting condition, the sending device is selected according to a predetermined order. For example, the image forming device 190 is selected it chronological order of registration in the information processing apparatus 100.

If no image forming device 190 has matched a selecting condition, an image forming device 190 that has matched a condition of a higher priority level may be selected. If only one image forming device 190 has matched a condition of a higher priority level, it is selected.

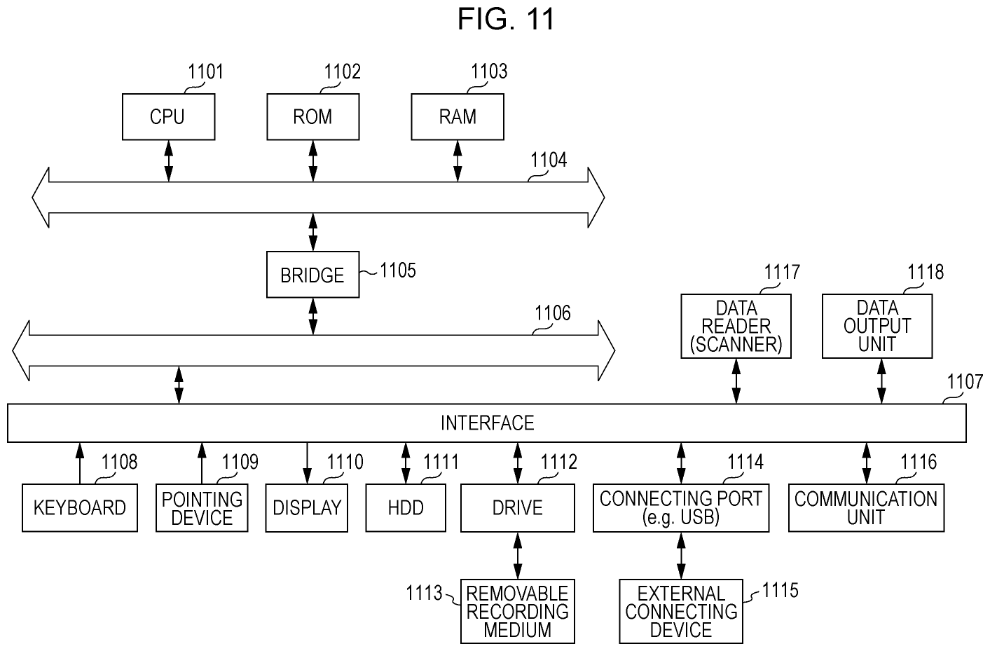

An example of the hardware configuration of the information processing apparatus 100 of the exemplary embodiment will be described below with reference to FIG. 11. The hardware configuration shown in FIG. 11 is implemented as a personal computer (PC), for example, and includes a data reader 1117, such as a scanner, and a data output unit 1118, such as a printer.

A CPU 1101 is a control unit that executes processing in accordance with a computer program describing an execution sequence of the modules of the above-described exemplary embodiment, that is, the print instruction receiving module 105, the print instruction analyzing module 110, the image forming device selecting module 125, the print instruction creating module 130, the print instruction sending module 140, and the image forming device information obtaining module 145.

A read only memory (ROM) 1102 stores programs and operation parameters used by the CPU 1101. A RAM 1103 stores programs used during the execution of the CPU 1101 and parameters which change appropriately during the execution of the programs. The CPU 1101, the ROM 1102, and the RAM 1103 are connected to one another via a host bus 1104, which is constituted by, for example, a CPU bus.

The host bus 1104 is connected to an external bus 1106, such as a peripheral component interconnect/interface (PCI) bus, via a bridge 1105.

A keyboard 1108 and a pointing device 1109, such as a mouse, are devices operated by an operator. A display 1110 is, for example, a liquid crystal display or a cathode ray tube (CRT), and displays various items of information as text or image information. Alternatively, a touchscreen having both of the functions of the pointing device 1109 and the display 1110 may be provided. In this case, to implement the function of the keyboard, a keyboard drawn on a screen (touchscreen) by using software, that is, a software keyboard or a screen keyboard, may be used instead of the keyboard 1108, which is a physical keyboard.

A hard disk drive (HDD) 1111 has a built-in hard disk (may alternatively be a flash memory, for example) and drives the hard disk so as to record or play back information or programs executed by the CPU 1101. The HDD 1111 implements the function of the information storage module 115, for example. Various other items of data and various other computer programs are also stored in the HDD 1111.

A drive 1112 reads data or a program recorded in a removable recording medium. 1113, such as a magnetic disk, an optical disc, a magneto-optical disk, or a semiconductor memory, and supplies the read data or program to the RAM 1103 via an interface 1107, the external bus 1106, the bridge 1105, and the host bus 1104. The removable recording medium 1113 is also usable as a data recording region.

A connecting port 1114 is a port for connecting the PC to an external connecting device 1115, and has a connecting portion, such as a universal serial bus (USE) port or an IEEE1394 port. The connecting port 1114 is connected to, for example, the CPU 1101, via the interface 1107, the external bus 1106, the bridge 1105, and the host bus 1104. A communication unit 1116 is connected to a communication line and executes data communication processing with an external source. The data reader 1117 is, for example, a scanner, and executes processing for reading documents. The data output unit 1118 is, for example, a printer, and executes processing for outputting document data.

The hardware configuration of the information processing apparatus 100 shown in FIG. 11 is only an example, and the exemplary embodiment may be configured in any manner in which the modules described in the exemplary embodiment are executable. For example, some modules may be configured as dedicated hardware (for example, an application specific integrated circuit (ASIC)), or some modules may be installed in an external system and be connected to the PC via a communication line. A system, such as that shown in FIG. 11, may be connected to a system, such as that shown in FIG. 11, via a communication line, and may be operated in cooperation with each other. Additionally, instead of into a PC, the modules may be integrated into a mobile information communication device (including a cellular phone, smartphone, a mobile device, and a wearable computer), a home information appliance, a robot, a copying machine, a fax machine, a scanner, a printer, and a multifunction device (image processing device including at least two functions among a scanner, a printer, a copying machine, and a fax machine).

The above-described program may be stored in a recording medium and be provided. The program recorded on a recording medium may be provided via a communication medium. In this case, the above-described program may be implemented as a “non-transitory computer readable medium storing the program therein” in the exemplary embodiment.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R, and DVD+RW, compact discs (CDs), and more specifically, a CD read only memory (CD-ROM), a CD recordable (CD-R), and a CD rewritable (CD-RW), Blu-ray (registered trademark) disc, a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be the entirety or part of another program, or may be recorded, together with another program, on a recording medium. The program may be divided and recorded on plural recording media. The program may be recorded in any form, for example, it may be compressed or encrypted, as long as it can be reconstructed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is it tended that the scope of the disclosure be defined by the following claims and their equivalents.

What is claimed is:

1. An information processing apparatus comprising:
a receiver that receives a print instruction;
an extractor that extracts a condition for selecting an image forming device from the print instruction;
a selector that selects an image forming device from among a plurality of image forming devices in accordance with the condition, the information processing apparatus being able to communicate with the plurality of image forming devices; and
a sender that sends the print instruction to the image forming device selected by the selector.

2. The information processing apparatus according to claim 1, further comprising:
an obtaining unit that obtains a status of each of the plurality of image forming devices,
wherein the selector selects an image forming device in a status which satisfies the condition.

3. The information processing apparatus according to claim 1, further comprising:
an obtaining unit that obtains an attribute of each of the plurality of image forming devices,
wherein the selector selects an image forming device having an attribute that satisfies the condition.

4. The information processing apparatus according to claim 1, wherein:
the condition is a condition set in the print instruction, a print attribute concerning the print instruction being also set in the print instruction; and
the selector selects an image forming device in accordance with the print attribute and the condition set in the print instruction.

5. The information processing apparatus according to claim 4, wherein, if the print attribute and the condition are inconsistent with each other, the selector selects an image forming device in accordance with the print attribute.

6. The information processing apparatus according to claim 1, wherein priority levels are provided for a plurality of the conditions set in the print instruction.

7. The information processing apparatus according to claim 6, wherein, if only one image forming device satisfies a condition of a higher priority level among the plurality of conditions, the selector selects the image forming device.

8. A non-transitory computer readable medium storing a program causing a computer to execute a process, the process comprising:
receiving a print instruction;
extracting a condition for selecting an image forming device from the print instruction;
selecting an image forming device from among a plurality of image forming devices in accordance with the condition, the computer being able to communicate with the plurality of image forming devices; and
sending the print instruction to the selected image forming device.

9. An information processing apparatus comprising:
receiving means for receiving a print instruction;
extracting means for extracting a condition for selecting an image forming device from the print instruction;
selecting means for selecting an image forming device from among a plurality of image forming devices in accordance with the condition, the information processing apparatus being able to communicate with the plurality of image forming devices; and
sending means for sending the print instruction to the image forming device selected by the selecting means.
